(19) United States
(12) Patent Application Publication
(10) Pub. No.: US 2026/0337457 A1
(43) Pub. Date: Oct. 29, 2026

(54) Magnetic Adhesive Decal, Tape, Label, Ink, or Film for Automatic Splicing and Joining Processes

(71) Applicant: Jason Jones, Cabot, AR (US)

(72) Inventor: Jason Jones, Cabot, AR (US)

(21) Appl. No.: 19/061,073

(22) Filed: Feb. 24, 2025

(51) Int. Cl. C09J 7/20

(52) U.S. Cl. CPC C09J 7/20; C09J 2203/334; C09J 2203/37; C09J 2301/124; C09J 2301/302

(57) ABSTRACT

A ferrous or magnetic adhesive material, such as a decal, tape, label, ink, or film, is disclosed for use in splicing or joining applications. The material incorporates a magnetic or ferromagnetic component to provide a strong holding force, along with an optional adhesive layer for enhanced bonding. The invention eliminates the need for vacuum systems or complicated processes, simplifying the workflow and improving efficiency in industries such as printing, packaging, and media production.

### 3. BACKGROUND OF THE INVENTION

In industries such as printing, packaging, and media production, splicing or joining materials often requires precise alignment and secure holding of substrates. Traditional methods rely on vacuum systems, mechanical clamps, or other complicated mechanisms to hold the substrate in place or out of the way during the process. These methods can be cumbersome, expensive, and time-consuming, often requiring specialized equipment and setup. There is a need for a simpler, more cost-effective solution that can securely hold substrates in place without the need for additional machinery or complex processes. It has also been documented personally and by clients that other joining/auto splicing methods or processes do not work as intended costing hundreds of thousands of dollars in process losses to said clients. An example being the joining or auto splicing process does not hold and breaks during production settings, due to being over complicated and unreliable.

### 4. BRIEF SUMMARY OF THE INVENTION

The present invention addresses this need by providing magnetic or ferromagnetic decal, tape, label, ink, or film that can be easily applied to substrates, enabling secure holding and precise alignment during splicing or joining. The invention is a flexible, thin material (such as a decal, tape, label, ink, or film) that incorporates magnetic or ferromagnetic properties. The material is designed to hold substrates in place during splicing or joining processes, saving time and eliminating the need for vacuum systems or complicated mechanical setups furthering cost savings. The invention may also include an adhesive layer or printable surface for additional functionality.

Key features of the invention include:
1. A magnetic or ferromagnetic layer that provides a strong holding force.
2. An optional adhesive layer for enhanced bonding.
3. The ability to be applied as a decal, tape, label, ink, or film.
4. Flexibility to conform to various substrates and shapes.
5. The ability to be easily repositioned or removed without residue.
6. Compatibility with a wide range of substrates, including paper, plastic, metal, and fabric.
7. Eliminates the need for vacuum systems or complex mechanical setups.

### 5. BRIEF DESCRIPTION OF DRAWINGS

FIG. 1 is a perspective view of a representative example of a splicing head of a machine that automates the splicing of the beginning of new substrate material and the ending of substrate material approaching depletion.

FIG. 2 is a side elevation view of the portion of FIG. 1 within circle 2 (rotated to a direct side elevation view), including the leading end of new substrate material, showing the alignment of the leading end of the lower portion of the new substrate and the trailing end of the old substrate (with lower splicing tape atop the embedded magnets), and showing the leading end of the upper portion of the new substrate (with upper splicing tape atop the magnetic roller).

FIG. 3 is a top plan view of the splicing head of FIG. 2.

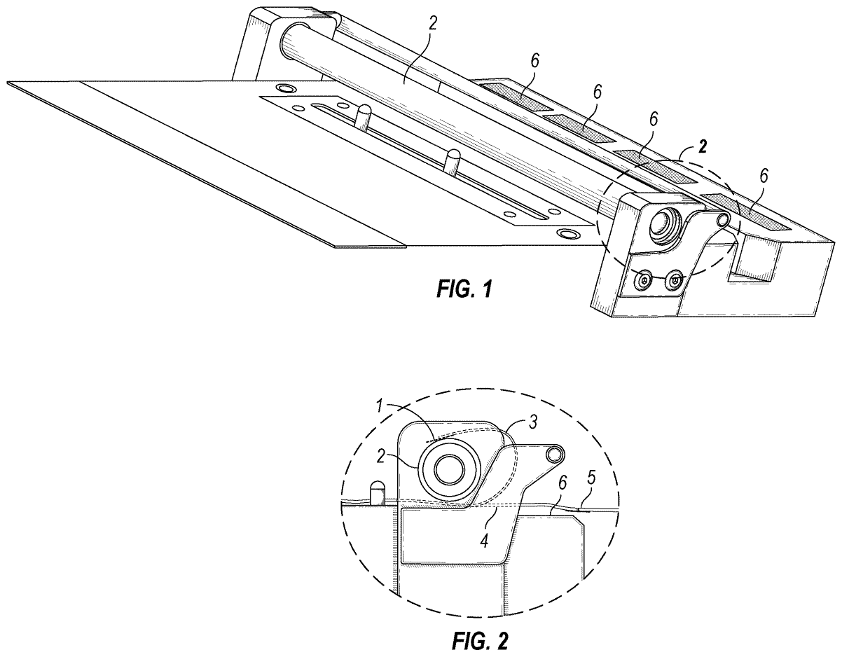

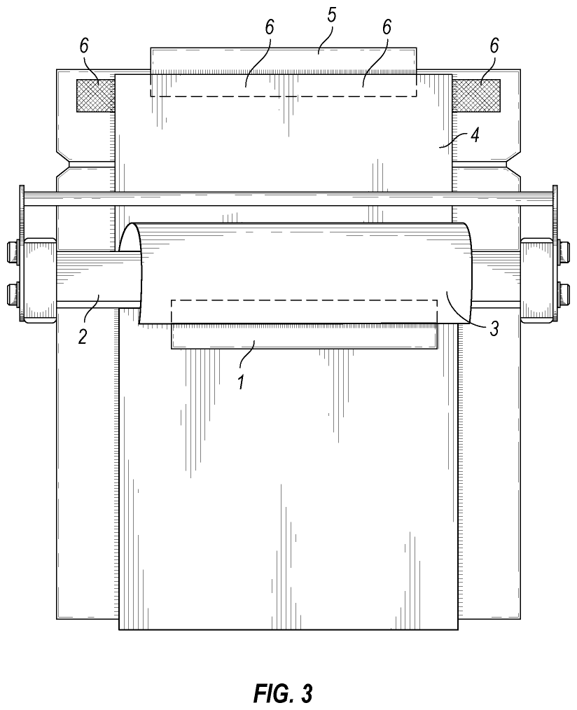

### 6. DETAILED DESCRIPTION OF THE INVENTION

The items or features having reference numerals are generally described as follows.

Reference Numeral 1, for Splicing Tape with Ferrous Ink (Upper): Splice Tape provides a method to adhere one material to another material, an example being film to film or label to label. Splice tape is ferrous, meaning it is magnetic in property. The Upper Splice Tape is used as needed, but most essential for a tube or sleeve material. It adheres to the Magnetic Roller to hold the material in the exact position required until the joining or auto splicing process is completed.

Reference Numeral 2, for Magnetic Roller: The Magnetic Roller is used to utilize a specific location to attach the material to via the ferrous splicing tape. It holds the label in place until the actual joining splice. Its second function is to roll forward, positioning the ferrous splice tape over the new film or label and applying pressure to both sides of said materials to create a strong, unbreakable bond between the two materials being joined.

Reference Numeral 3, for Material Being Spliced (Upper Layer): Label, Film, Substrate, Paper or Fabric. When an applicable tube or sleeve material is being utilized. In a single plane material (non-tubular), it will be omitted from the process.

Reference Numeral 4, for Material being Spliced (Lower Layer): Label, Film, Substrate, Paper or Fabric. Always utilized with any material, whether single plane or tubular in nature.

Reference Numeral 5, for Splicing Tape with Ferrous Ink (Lower): Splice Tape provides a method to adhere one material to another material, an example being film to film or label to label. Splice tape is ferrous, meaning it is magnetic in property. The Lower Splice Tape is always utilized, whether single plane or tubular in nature. It adheres to the embedded magnets and holds the material in the exact position required until the joining or auto splicing process is completed.

Reference Numeral 6, for Lower Embedded Magnets: These embedded magnets allow the ferrous splicing tape to be held in position until the magnetic roller presses one or both sides of the label together.
1. “Material” in drawings reference substrates, paper, film, label or fabric.
2. The Material to be joined or spliced may be one-sided, two-sided, be affixed with graphics or pressure sensitive labels. It may also be a tube or sleeve Material.
3. The joining or auto splicing process begins with the operator preparing a joining/auto splicing setup of the Material.
4. The operator inserts the Material into the joining/auto splicing assembly.
5. If Material is a tube or sleeve type, then ferrous/magnetic tape (1,5) is placed on both upper (3) and lower outside (4) portions of the Material, leaving exposed adhesive surfaces of the ferrous/magnetic tape (1,5) to secure to the old Material.
6. After ferrous/magnetic tape (1,5) is prepared on the Material, then it is magnetically affixed to the magnetic roller (2) (if applicable, See #10 below) and lower embedded magnets (6) of the assembly. This securely holds the Material in place until time of joining/auto splicing.
7. As the current Material expires or is nearly empty, the machine feeding mechanism transitions to the newly prepared joining/splicing assembly.
8. The magnetic roller (2) moves forward over the new Material (1,3,4,5), pressing the previously ferrous/magnetically taped (1,5) new Material (3,4) over and onto the old Material, creating a secure bond between the new and old Material.
9. The feeding mechanism now transitions back to normal operation by pulling newly joined/auto spliced Material through the assembly, thus completing the joining/auto splicing process.
10. If the Material is not a tube or sleeve Material, the process remains the same, exempting the upper ferrous/magnetic tape (1) and upper Material (3) from the process, only needing the lower ferrous/magnetic tape (5) to be applied to the lower Material (4) and magnetically affixed to the lower embedded magnets (6). The magnetic roller (2) again presses together new and old Material, adhering the bond, completing the joining/auto splicing process.
11. The above procedure describes how the ferrous/magnetic tape (1,5) provides the secure bond for either Material (3,4) in the correct position and securely affixes and adheres the one or two Materials together to create a seamless, unbreakable transition between old and new Material. The ferrous/magnetic tape (1,5) and process thereof, eliminates the need for air, venturis or vacuum. It also eliminates the need for over-engineered devices such as presses, clamps or grippers to hold Material in place for joining/auto splicing.

1. A magnetic adhesive material being comprised of a magnetic or ferromagnetic component with an adhesive layer applied to one or both sides of the magnetic component and a protective film or coating to preserve the integrity of the material.

2. The material of claim 1, wherein the magnetic or ferromagnetic component is flexible and conformable to various substrates.

3. The material of claim 1, wherein the adhesive layer is pressure-sensitive and removable.

4. The material of claim 1, further comprises a printable surface or ink formulation for customization or labeling.

5. A method for splicing or joining substrates using the magnetic adhesive material of claim 1, allowing alignment of substrates to be joined and applying the magnetic adhesive material to hold the substrates in place, with adjustable positioning of the substrates as needed with optional additional adhesive or fastening methods for permanent bonding.

6. The material of claim 1, wherein the magnetic adhesive material is used in printing, packaging, or media production applications.

7. The material of claim 1, wherein the magnetic adhesive material eliminates the need for vacuum systems or complex mechanical setups during splicing or joining processes.
